(19) United States
(12) Patent Application Publication
(10) Pub. No.: US 2005/0178227 A1
(43) Pub. Date: Aug. 18, 2005

(54) Ball screw device

(75) Inventor: Junji Minakuchi, Gunma (JP)

Correspondence Address: SUGHRUE MION, PLLC, 2100 PENNSYLVANIA AVENUE, N.W., SUITE 800, WASHINGTON, DC, 20037, US

(73) Assignees: NSK LTD.; NSK Precision Co. Ltd.

(21) Appl. No.: 11/051,542

(22) Filed: Feb. 7, 2005

(30) Foreign Application Priority Data
Feb. 5, 2004 (JP) P.2004-029694

(51) Int. Cl. F16H 25/22

(52) U.S. Cl. 74/424.81; 74/424.82

(57) ABSTRACT

The contact angle α of ball 15 with respect to ball screw grooves 13, 14 is predetermined to a range of from not smaller than 35° to not greater than 45°. In this arrangement, the contact ellipsoid 15a of ball 15 can be prevented from running onto the beveled surface 18a of land area even when a thrust load acts on screw shaft 11 or nut 12. Accordingly, it is possible to provide a ball screw device which is not subject to easy generation of exfoliation due to hydrogen embrittlement caused by metal contact accompanying sudden rise of pressure on the contact area of ball screw groove with ball.

The present application claims foreign priority under 35 USC119 based on Japanese Patent Application No. 2004-029694, filed on Feb. 5, 2004, the contents of which is incorporated herein by reference in its entirety, and concurrently with the filing of this U.S. patent application.

### BACKGROUND OF THE INVENTION

1. Field of the Invention

The present invention relates to improvements in ball screw devices which are used under high load conditions.

2. Description of the Related Art

In general, a ball screw device is used in the feeding mechanism of various machines as a device of converting rotary movement to linear movement. A ball screw device adapted for electric injecting molding machine or press molding machine is often used under conditions of high temperature, high rotary speed, high load, etc. Therefore, when the ball screw device is used under such high load conditions, the grease can be decomposed to produce hydrogen which then penetrates the material of the screw shaft, nut, ball, etc., causing exfoliation due to hydrogen embrittlement accompanied by whitening of the metal texture. Further, since the electric injecting molding machine or press molding machine repeats operation and suspension, the water content in the air becomes water drop that is then attached to the screw shaft, nut, etc. during the suspension of the machine. The water drop which has thus been attached to the screw shaft, nut, etc. then enters in the grease to accelerate the generation of hydrogen.

Therefore, a technique which comprises incorporating a passivating oxidizer in the grease to inhibit exfoliation due to hydrogen embrittlement or hydrogen generation has been proposed (see Japanese Patent Examined Publication No. JP-B-2,878,749).

In the related art ball screw device, however, when a thrust load acts on the screw shaft or nut, the resulting elastic deformation of the ball causes the contact angle of the ball with respect to the ball screw grooves to rise from the initial predetermined value. Thus, the contact ellipsoid of the ball runs onto the beveled surface of the land area, causing sudden rise of pressure on the contact area of the ball screw grooves with the ball. During the operation of the ball screw device, the film of lubricant renders the screw shaft and the nut electrically insulated from the ball. However, as the pressure on the contact area rises, they are electrically conducted due to metal contact. Accordingly, when static electricity is generated across the pulley and the belt which drive the screw shaft, a potential difference is generated between the screw shaft and the ball and between the ball and the nut, resulting in the electrolysis of water content in the grease that accelerates the generation of hydrogen ion. At the same time, hydrogen penetrates the fresh surface produced by metal contact to help generate exfoliation due to hydrogen embrittlement.

### SUMMARY OF THE INVENTION

The invention has been worked out focusing on the aforementioned problems. An aim of the invention is to provide a ball screw device which is not subject to easy generation of exfoliation due to hydrogen embrittlement caused by metal contact accompanying sudden rise of pressure on the contact area of ball screw groove with ball.

In order to accomplish the aforementioned aims of the invention, a first aspect of the present invention relates to a ball screw device comprising a screw shaft, a nut having a ball screw groove provided on the inner surface thereof opposed to a ball screw groove formed on the outer surface of the screw shaft and a large number of balls incorporated rollably in the space between the ball screw groove of the screw shaft and the nut, wherein the contact angle of the ball with respect to at least one of the ball screw grooves is from not smaller than 35° to not greater than 45°.

Further, in the above-mentioned invention, it is preferable that a spacer is provided interposed between adjacent two balls among the large number of balls.

In accordance with the ball screw device according to the invention, the contact angle of the ball with respect to the ball screw groove is predetermined to a range of from not smaller than 35° to not greater than 45°, making it possible to prevent easy generation of exfoliation due to hydrogen embrittlement caused by metal contact accompanying sudden rise of pressure on the contact area of ball screw groove with ball because the contact ellipsoid of ball doesn't run onto the beveled portion of land area to cause sudden rise of pressure on the contact area even when the thrust load acts on the screw shaft or nut.

### BRIEF DESCRIPTION OF THE DRAWINGS

FIG. 1 is a sectional diagram illustrating the schematic configuration of a ball screw device according to an embodiment of implementation of the invention;

FIG. 2 is a diagram illustrating the contact angle of a ball with respect to a ball screw groove; and

FIG. 3 is a diagram illustrating the relationship between the calculated life ratio of a ball screw device and the contact angle of a ball shown when the contact angle α of the ball is varied by 5° at a time within a range of from 30° to 60°.

### DETAILED DESCRIPTION OF THE PREFERRED EMBODIMENTS

An embodiment of implementation of the invention will be described hereinafter in connection with the attached drawings.

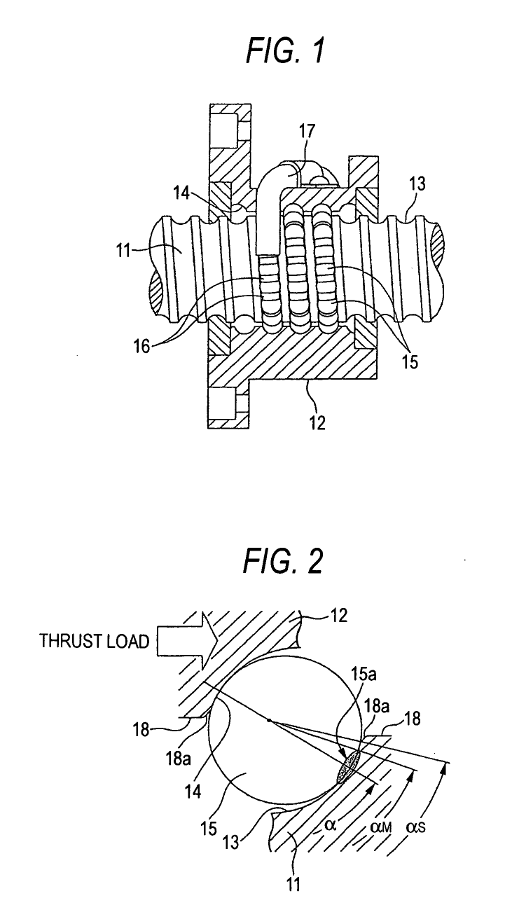

An embodiment of implementation of the ball screw device according to the invention is shown in FIGS. 1 and 2. In FIG. 1, the reference numeral 11 indicates a screw shaft and the reference numeral 12 indicates a nut. The screw shaft 11 has a ball screw groove 13 formed on the outer surface thereof. The ball screw groove 13 is opposed to a ball screw groove 14 formed on the inner surface of the nut 12. A large number of balls 15 are rollably incorporated in the space between the ball screw groove 13 and the ball screw groove 14. These balls 15 are arranged to roll over the ball screw grooves 13, 14 when the screw shaft 11 or the nut 12 rotates around the axis. A spacer made of a softer material than ball 15 (e.g., synthetic resin) is provided interposed between adjacent two balls 15, 15.

The ball 15 comes in contact with the ball screw grooves 13, 14 at an angle α of from 35° to 45°. A thrust load is imposed on the screw shaft 11 or the nut 12. The ball 15 which has rolled over the ball screw grooves 13, 14 is circulated through a ball circulating tube 17 which is a ball circulating member.

By predetermining the contact angle α of the ball 15 with respect to the ball screw grooves 13, 14 to a range of 35°≦θ≦45° as mentioned above, easy generation of exfoliation due to hydrogen embrittlement caused by metal contact accompanying sudden rise of pressure on the contact area of the ball screw grooves 13, 14 with the ball 15 can be prevented because the contact ellipsoid 15a of the ball 15 (see FIG. 2) doesn't run onto the beveled surface 18a of the land area to cause sudden rise of pressure on the contact area even when a thrust load acts on the screw shaft 11 or the nut 12.

In other words, when a thrust load acts on the screw shaft 11 or the nut 12, the resulting elastic deformation of the ball 15 causes the contact angle α of the ball 15 with respect to the ball screw grooves 13, 14 to rise from the initial predetermined value. Under these conditions, when the upper limit αM of the contact angle α (see FIG. 2) exceeds the upper limit αs of the angle of the ball screw groove, the area of the contact ellipsoid 15a increases to cause sudden rise of pressure on the contact area of the ball screw groove with the ball. In the invention, however, easy generation of exfoliation due to hydrogen embrittlement caused by metal contact accompanying sudden rise of pressure on the contact area of the ball screw grooves 13, 14 with the ball 15 can be prevented because the upper limit αM of the contact angle α doesn't exceed the upper limit αs of the angle of the ball screw even when a thrust load acts on the screw shaft 11 or the nut 12.

Further, in the aforementioned embodiment, the retainer 16 is provided interposed between adjacent two balls 15, 15, making it possible to prevent contact of the balls and hence eliminate the generation of vibration and noise due to contact of the balls.

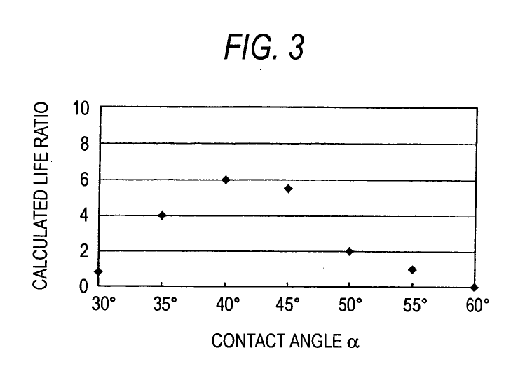

The inventors made a durable life test on a Type 36×10-C5 ball screw device (produced by NSK Ltd.; ball diameter: 3.175 mm) with the contact angle α predetermined to 30°, 35°, 40°, 45°, 50°, 55° and 60° using a ball screw durable life testing machine (produced by NSK Ltd.; pilot pressure load: 500 N; testing load: axial load=1,000 N; accelerated load=750-1,500 N; maximum rotary speed: 1,000 min⁻¹; stroke: 500 mm; lubricating grease: MY2 (produced by LUBE Corporation)) ten times for each contact angle. The time required until the ball screw groove undergoes exfoliation was then measured. The measurements were then averaged to determine the ratio of the actual life to the calculated life. The results are shown in FIG. 3.

As can be seen in the experimental results shown in FIG. 3, when the contact angle α of the ball deviates from the range of 35°≦θ≦45°, the durable life of the ball screw groove shows sudden drop. This is because when the contact angle α of the ball deviates from the range of 35°≦θ≦45°, the thrust load acting on the screw shaft or the nut causes the contact ellipsoid of the ball to run onto the beveled surface of the land area, causing sudden rise of pressure on the contact area of the ball screw groove with the ball that leads to metal contact as mentioned above.

Accordingly, as can be seen in the aforementioned experimental results, by predetermining the contact angle α of the ball to a range of from not smaller than 35° to not greater than 45°, easy generation of exfoliation due to hydrogen embrittlement caused by metal contact accompanying sudden rise of pressure on the contact area of the ball screw grooves with the ball can be prevented because the contact ellipsoid of the ball doesn't run onto the beveled surface of the land area to cause sudden rise of pressure on the contact area even when a thrust load acts on the screw shaft or the nut.

While the foregoing embodiment has been described with reference to the tube type ball screw device comprising a ball circulating tube as a ball circulating member, the invention is not limited thereto. For example, the invention can be applied to an end cap type ball screw device comprising an end cap as a ball circulating member or internal ball deflector type ball screw device or an end deflector type ball screw device comprising a circulating member provided at the both ends of nut.

While the invention has been described above with reference to the embodiment, the technical range of the invention is not restricted to the range described in the embodiment. It is apparent to the skilled in the art that various changes or improvements can be made in the embodiment. It is apparent from the appended claims that the embodiment thus changed or improved can also be included in the technical range of the invention.

1. A ball screw device comprising:
a screw shaft having a ball screw groove provided on an outer surface thereof;
a nut having a ball screw groove provided on an inner surface thereof opposed to ball screw groove of the screw shaft; and
a large number of balls incorporated rollably in a space defined between the ball screw grooves of the screw shaft and the nut,
wherein the contact angle of the ball with respect to at least one of the ball screw grooves is set in the range from not smaller than 35° to not greater than 45°.

2. The ball screw device as defined in claim 1, wherein the contact angle of the ball with respect to both of the ball screw grooves is set in the range from not smaller than 35° to not greater than 45°.

3. The ball screw device as defined in claim 1, further comprising:
a spacer interposed between adjacent two balls.
